(19) United States
(12) Patent Application Publication
(10) Pub. No.: US 2004/0017742 A1
(43) Pub. Date: Jan. 29, 2004

(54) Optical head and optical disk drive

(75) Inventor: Katsuo Iwata, Tokyo (JP)

Correspondence Address: PILLSBURY WINTHROP, LLP, P.O. BOX 10500, MCLEAN, VA, 22102, US

(73) Assignee: Kabushiki Kaisha Toshiba, Tokyo (JP)

(21) Appl. No.: 10/455,792

(22) Filed: Jun. 6, 2003

(30) Foreign Application Priority Data
Jun. 7, 2002 (JP) 2002-167154

(51) Int. Cl. G11B 7/095

(52) U.S. Cl. 369/44.32; 369/53.14; 369/112.24

(57) ABSTRACT

A light beam emitted from a light source is diffracted into a first light beam and a pair of second light beams, which in turn are furnished with spherical aberration components based on an externally applied control input signal. The first light beam and the pair of second light beams furnished with spherical aberration components are focused by an objective lens on the recording layer of an optical disk. Each of the first light beam and the pair of second light beams reflected from the recording layer of the optical disk and transmitted through the objective lens is received by a corresponding photodetector.

### CROSS-REFERENCE TO RELATED APPLICATIONS

This application is based upon and claims the benefit of priority from the prior Japanese Patent Application No. 2002-167154, filed Jun. 7, 2002, the entire contents of which are incorporated herein by reference.

### BACKGROUND OF THE INVENTION

1. Field of the Invention

The present invention relates to an optical head and an optical disk drive which record or reproduce information onto or from an optical disk and more particularly to a technique to detect the thickness of the transmissive substrate of the optical disk.

2. Description of the Related Art

As is well known, an optical disk is structured such that the information recording layer is sandwiched between a transmissive substrate and a hard protective layer. A beam of light emitted from an optical head is directed through the transmissive substrate onto the information recording layer, whereby information is recorded onto or reproduced from the information recording layer.

In general, optical disks are subject to variations in the thickness of their transmissive substrates due to variations in manufacture. There arises a thickness error (a deviation from the design value) of the order of several tens of micrometers (μm). When a beam of light passes through a transmissive substrate with a thickness error and falls on the information recording layer, the shape of the resultant spot of light on that layer changes due to spherical aberration.

A change in the light spot shape causes degradations in how accurately information can be written onto the recording layer (recording accuracy) and how accurately information can be read from the recording layer (reproduction accuracy). This makes it difficult to record or reproduce information onto or from an optical disk with accuracy and stability.

In order to record or reproduce information onto or from an optical disk with accuracy and stability, therefore, it is required to provide the optical head with a function of compensating for spherical aberration due to an error in thickness of the transmissive substrate to mitigate the change in light spot shape resulting from the spherical aberration within some tolerance.

Compensation of spherical aberration requires accurately detecting the amount of the resultant spherical aberration or error in thickness of the transmissive substrate. Means for detecting the thickness of the transmissive substrate include a technique disclosed in, for example, Japanese Unexamined Patent Publication No. 2000-76665 published Mar. 14, 2000.

According to this technique, to a normal optical head are added means for producing a light beam dedicated to measuring the thickness of the transmissive substrate and means for detecting that light beam.

To be specific, the thickness of the transmissive substrate is detected by changing the curvature of the central region of an objective lens and using a central portion of a light beam that passes through the objective lens. Also, first-order diffracted light from a hologram element placed in the optical path is employed to detect the thickness of the transmissive substrate.

Reflected light from the recording layer and reflected light from the surface of the transmissive substrate are conducted to a detecting hologram and divided into a light beam processed into a reproduced signal, a focus error signal, etc., and a light beam for detecting the thickness of the transmissive substrate. Each of the light beams is detected by a corresponding photodetector and arithmetic operation processing is then performed on the photodetector outputs.

The arithmetic operation processing is to take the difference between a focus error signal based on the reflected light from the recording layer and a signal obtained by multiplying a signal based on the reflected light from the surface of the transmissive layer by a given proportional coefficient. The difference signal is taken as the detect signal for the thickness of the transmissive substrate.

However, with the system in which the curvature of the central region of the objective lens is changed, since the optical path of the light beam before falling on the recording layer differs from that of the light beam reflected from the recording layer, the signal separation is difficult. That is, it is difficult to obtain an accurate thickness detect signal.

In addition, since the reflected light from the recording layer and the reflected light from the surface of the transmissive substrate are separated by the hologram element having the diffraction effect, the detectable range of errors in thickness of the transmissive substrate is limited to the same range as the focus error signal.

On the other hand, with the technique to detect the thickness of the transmissive substrate using the first-order diffracted light by the hologram element placed in the optical path, zero-order diffracted light and higher-order diffracted light are produced at the time when a light beam is directed onto the disk and at the time when it is reflected from the disk, respectively. This also makes the signal separation difficult.

### BRIEF SUMMARY OF THE INVENTION

According to an aspect of the present invention, there is provided an optical head comprising: a diffraction unit configured to diffract an incident beam of light emitted from a light source into a first light beam and a pair of second light beams; a spherical aberration compensator configured to impart spherical aberration components based on an externally applied control input to the first light beam and the pair of second light beams output from the diffraction unit; an objective lens configured to focus the first light beam and the pair of second light beams output from the spherical aberration compensator onto the recording layer of an optical disk; and a photosensor configured to have light receiving sections each of which receives a corresponding one of the first light beam and the pair of second light beams reflected from the recording layer of the optical disk and transmitted through the objective lens.

According to another aspect of the present invention, there is provided an optical disk drive comprising: an optical head comprising a diffraction unit configured to diffract an incident beam of light emitted from a light source into a first light beam and a pair of second light beams, a spherical aberration compensator configured to impart spherical aberration components based on an externally applied control signal to the first light beam and the pair of second light beams output from the diffraction unit, an objective lens configured to focus the first light beam and the pair of second light beams output from the spherical aberration compensator onto the recording layer of an optical disk, and a photosensor configured to have light receiving sections each of which receives a corresponding one of the first light beam and the pair of second light beams reflected from the recording layer of the optical disk and transmitted through the objective lens; and a detecting unit configured to detect an error in the thickness of the transmissive substrate of the optical disk on the basis of outputs of the photosensor.

### BRIEF DESCRIPTION OF THE SEVERAL VIEWS OF THE DRAWING

FIG. 1 shows the optical system of an optical head according to an embodiment of the present invention;

FIG. 2 is a diagram for use in explanation of spots of light focused onto the recording layer of an optical disk with no transmissive substrate thickness error in the embodiment;

FIG. 3 is a diagram for use in explanation of a photosensor in the embodiment;

FIGS. 4A and 4B are diagrams for use in explanation of tracking error signals produced from ±first-order reflected light when the transmissive substrate has no thickness error;

FIG. 5 is a diagram for use in explanation of spots of light formed on the recording layer of an optical disk in which its transmissive substrate has an error in thickness in the embodiment;

FIGS. 6A and 6B are diagrams for use in explanation of tracking error signals produced from ±first-order reflected light when the transmissive substrate has an error in thickness;

FIG. 7 shows wavefront aberration versus transmissive substrate thickness for zero- and ±first-order light in the embodiment; and

FIG. 8 is a system block diagram of an optical disk drive provided with means for compensating for variations in the thickness of transmissive substrates in accordance with the embodiment.

### DETAILED DESCRIPTION OF THE INVENTION

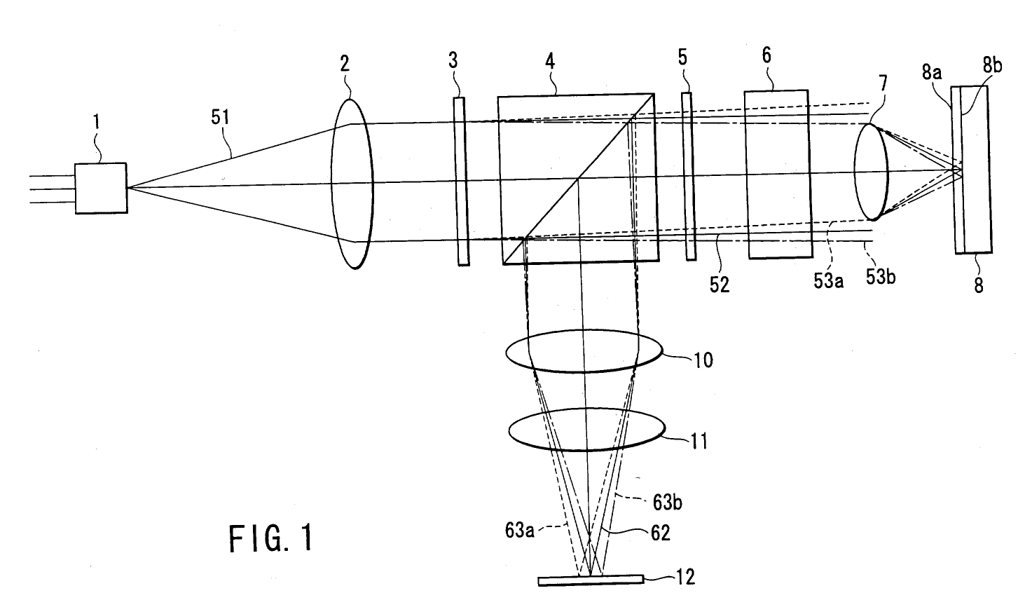

An embodiment of the present invention will be described hereinafter with reference to the accompanying drawings. FIG. 1 shows the optical system of an optical head according to this embodiment. An outgoing ray of light 51 from a semiconductor laser source 1 is converted by a collimator lens 2 into a beam of parallel light, which in turn falls on a hologram 3.

The hologram 3 diffracts the incident beam of light to produce a zero-order diffracted light component 52 serving as a light beam for recording and reproduction of information and ±first-order diffracted light components 53a and 53b serving as light beams for detecting an error in thickness of the transmissive substrate 8a of an optical disk 8 to be described later. The wavefronts of the ±first-order light components 53a and 53b, diffracted by the hologram 3, have tilt components of opposite polarization and spherical aberration components of opposite polarization but of the same amount.

The zero-order diffracted light component 52 and the ±first-order diffracted light components 53a and 53b emerging from the hologram 3 pass through a polarizing beam splitter 4, a quarter-wavelength (λ/4) plate 5 and a spherical aberration compensator 6 and are then focused by an objective lens 7 onto the recording layer 8b of the optical disk 8 through its transmissive substrate 8a.

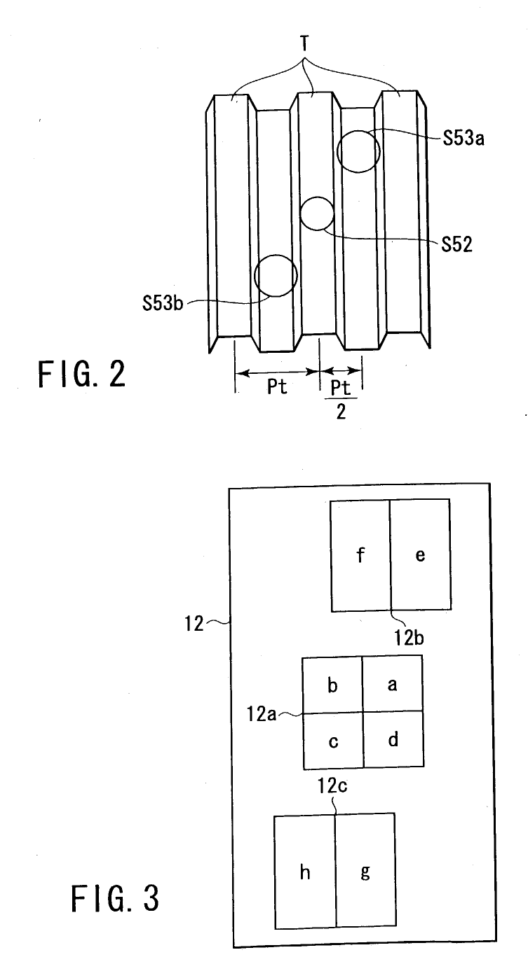

Here, a description is given of a case where the thickness of the transmissive substrate 8a is equal to the design value (e.g., 0.1 mm). In this case, the zero-order light component 52 focused by the objective lens 7 forms a spot S52 with little aberration on the recording layer 8b as shown in FIG. 2.

The hologram-based tilt components in the ±first-order diffracted light components 53a and 53b focused by the objective lens 7 respectively form spots S53a and S53b at those positions on the recording layer 8b which are different from the position of the spot S52 formed by the zero-order diffracted light 52.

In this case, the spots S53a and S53b produced by the ±first-order diffracted light components 53a and 53b will have larger diameters than the spot S52 produced by the zero-order diffracted light component 52 because of their spherical aberration components imparted by the hologram 3.

Assume here that the spacing of tracks T formed on the recording layer 8b in the tracking direction (i.e., in the direction of radius of the optical disk 8) is Pt. Then, the spots S53a and S53b formed by the ±first-order light components 53a and 53b will be offset from the spot S52 formed by the zero-order light component 52 by ±Pt/2 in the tracking direction of the optical disk 8.

The spots S53a and S53b are made equal in diameter to each other because of the spherical aberration components of opposite polarization but of the same amount in the ±first-order diffracted light components 53a and 53b.

At the surface of the recording layer 8b the zero-order light 52 is reflected as reflected light 62 and the ±first-order light 53a and 53b is reflected as reflected light 63a and 63b. This reflected light travels backward through the objective lens 7, the spherical aberration compensator 6 and the quarter-wavelength plate 5, then is reflected at approximately right angles by the polarizing beam splitter 4 and received by a photosensor 12 through a condenser lens 10 and a cylindrical lens 11 that form an astigmatism detection system.

The photosensor 12 is provided, as shown in FIG. 3, with three light receiving sections 12a, 12b and 12c. The first light receiving section 12a is comprised of four light receiving areas a, b, c, and d that receive the reflected light 62 corresponding to the zero-order light 52. The second light receiving section 12b is comprised of two light receiving areas e and f that receive the reflected light 63a corresponding to the ±first-order light 53a. The third light receiving section 12c is composed of two light receiving areas g and h that receive the reflected light 63b corresponding to the −first-order light 53b.

The reflected light 62 corresponding to the zero-order light 52 is used to produce a signal HF corresponding to the recorded information, an astigmatism-based focus error signal FE and a push-pull-based tracking error signal. These signals are produced by performing the following operations on the outputs of the light receiving areas a, b, c and d of the light receiving section 12a:

HF=a+b+c+d

FE=(a+c)−(b+d)

TE=(a+d)−(b+c)

The reflected light 63a and 63b corresponding to the ±first-order diffracted light 53a and 53b is used to produce push-pull-based tracking error signals TEa and TEb. These signals are produced by performing the following operations on the outputs of the light receiving areas e, f, g and h of the light receiving sections 12b and 12c:

TEa=e−f

TEb=g−h

In general, the amplitude level of the tracking error signal depends on the size of the spot on the recording layer 8b. The smaller the spot size, the greater the amplitude level becomes.

The thickness of the transmissive substrate 8a is now supposed to be equal to the design value. As shown in FIG. 2, therefore, the spots S53a and S53b formed by the ±first-order diffracted light 53a and 53b are made equal in diameter to each other.

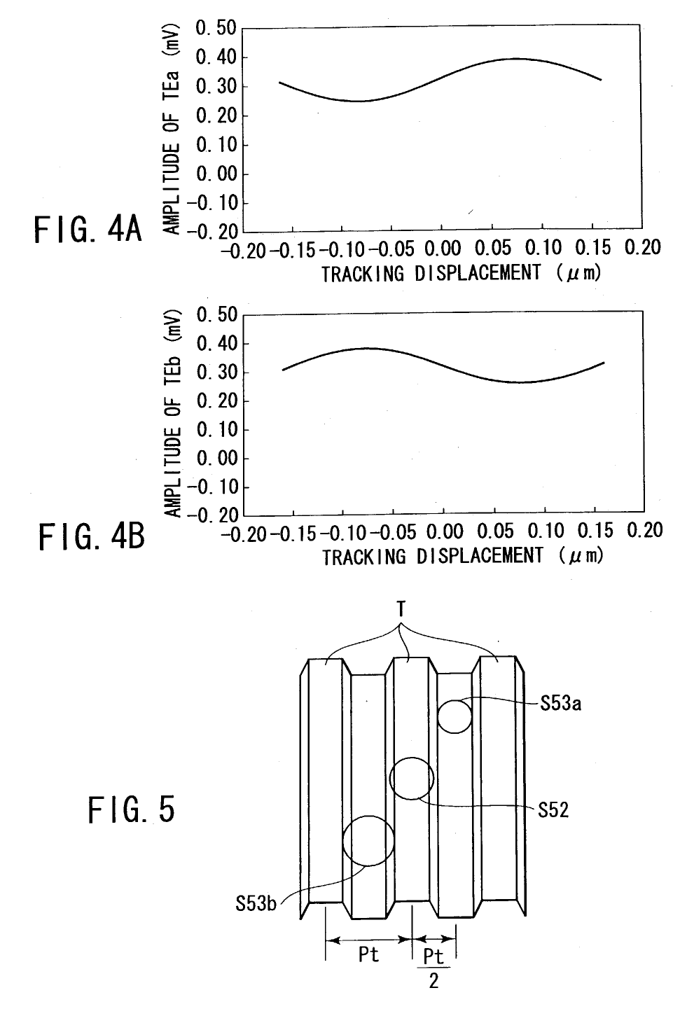

For this reason, as shown in FIGS. 4A and 4B, the tracking error signals TEa and TEb produced from the reflected light 63a and 63b corresponding to the ±first-order diffracted light 53a and 53b have their amplitude levels varied by equal amounts in the opposite directions with reference to a certain level as the tracking displacement varies.

Next, consider the case where the thickness of the transmissive substrate 8a differs from the design value (e.g., 0.1 mm). In this case, the zero-order light 52 focused by the objective lens 7, which has undergone spherical aberration dependent on the magnitude of a thickness error in the transmissive substrate 8a, will form on the recording layer 8b a spot S52 which is larger in diameter than at non-aberration time, as shown in FIG. 5.

The ±first-order light 53a and 53b focused by the objective lens 7 will form spots S53a and S53b in positions which are offset from the position of the spot S52 formed by the zero-order light 52 by ±Pt/2 in the tracking direction of the optical disk 8.

In this case, there is a difference in the amount of spherical aberration between the spots S53a and S53b formed by the ±first-order light 53a and 53b because the spherical aberration dependent on the magnitude of a thickness error in the transmissive substrate 8a is added to the spherical aberration components imparted by the hologram 3. That is, the spots S53a and S53b formed by the ±first-order light 53a and 53b will become different in size from each other.

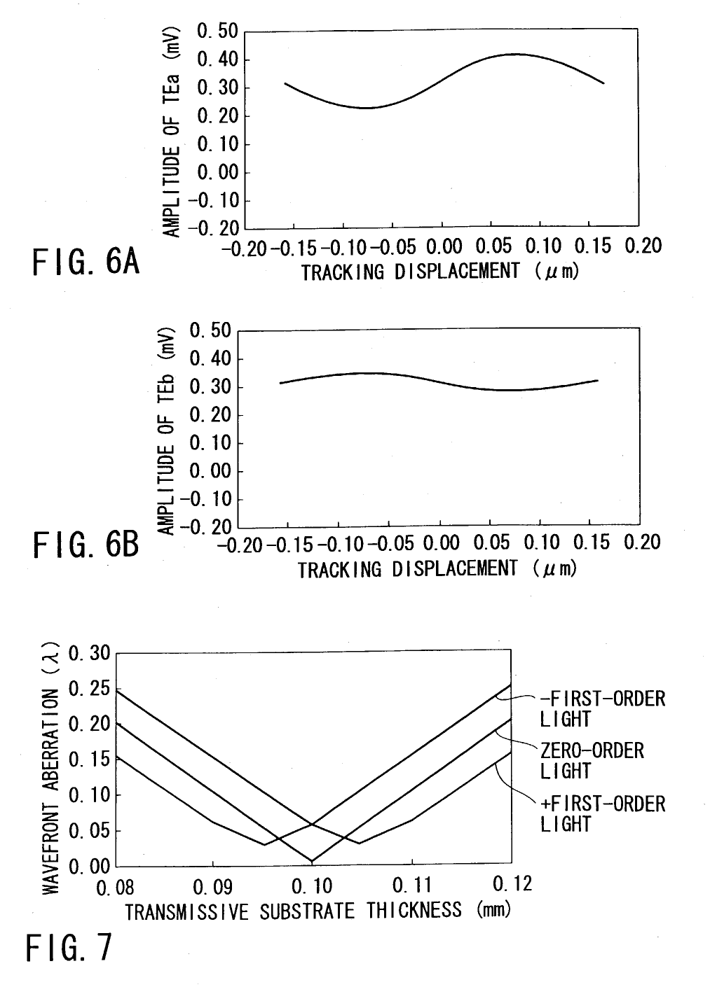

For this reason, as shown in FIGS. 6A and 6B, the tracking error signals TEa and TEb produced from the reflected light 63a and 63b corresponding to the ±first-order diffracted light 53a and 53b will not have their amplitude levels varied by equal amounts in opposite directions as the tracking displacement varies.

That is, when the thickness of the transmissive substrate 8a is equal to the design value, the tracking error signals TEa and TEb produced from the reflected light 63a and 63b corresponding to the −first-order diffracted light 53a and 53b are equal in amplitude level to each other. Otherwise, the amplitude levels of the tracking error signals TEa and TEb are not equal to each other.

Thus, since the difference in amplitude level between the tracking error signals TEa and TEb corresponds to the error in thickness of the transmissive substrate 8a, a transmissive substrate thickness error signal SE can be obtained by performing an arithmetic operation of ampTEa−ampTEb. The polarity of the error signal SE indicates the direction of the thickness error of the transmissive substrate 8a, that is, whether its thickness is larger or smaller than the design value. The absolute value of the error signal SE indicates the magnitude of the thickness error.

Next, the servo control sequence for compensating for the thickness error in the transmissive substrate 8a will be described. First, the focus error signal FE is produced based on the reflected light 62 corresponding to the zero-order light 52 and used to control the objective lens 7 so as to keep the spot in focus. The tracking error signals TE, TEa and TEb and the transmissive substrate thickness error signal SE are produced on the basis of the reflected light 62, 63a and 63b under in-focus conditions. The compensation of the transmissive substrate thickness error is made using the transmissive substrate thickness error signal SE as will be described later and then tracking control is carried out using the tracking error signal TE.

The detection sensitivity of the transmissive substrate thickness error signal SE will be described next. The detection sensitivity of the transmissive substrate thickness error signal SE depends on the difference in size between the spots S53a and S53b formed by the ±first-order light 53a and 53b when there is an error in the thickness of the transmissive substrate 8a. That is, the sensitivity depends on the amounts of spherical aberration imparted to the ±first-order light 53a and 53b by the hologram 3.

FIG. 7 shows wavefront aberration versus transmissive substrate thickness for zero-order light and ±first-order light when the amount of spherical aberration imparted by the hologram 3 is set equal to the amount of spherical aberration that occurs when the thickness of the transmissive substrate 8a deviates from the design value by, say, 5 μm.

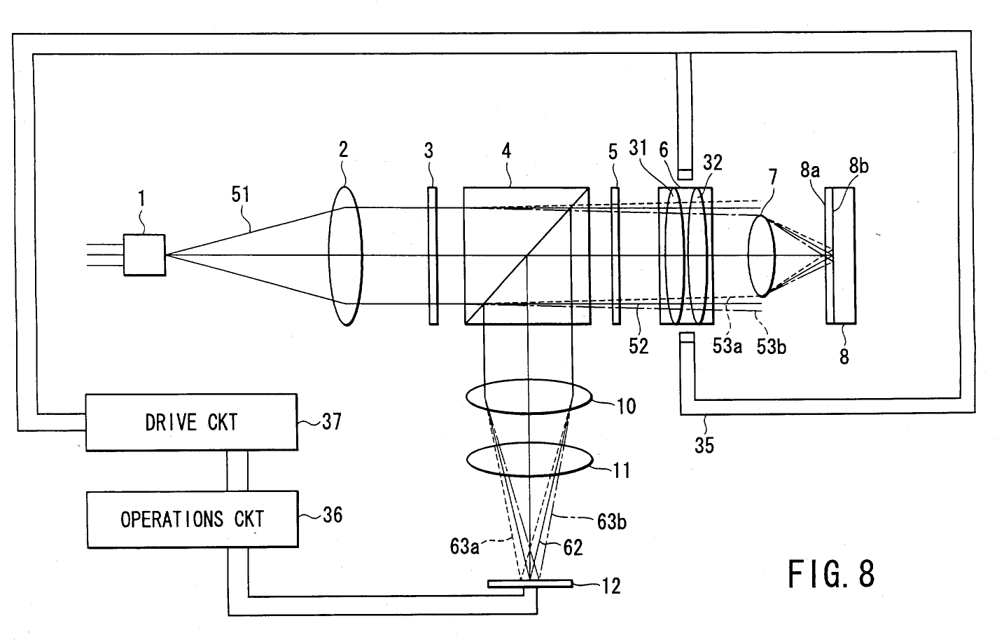

Next, compensation control of the error in the thickness of the transmissive substrate 8a will be described. This involves determining the amount of compensation of spherical aberration from the transmissive substrate thickness error signal SE and then carrying out a compensation operation based on the resultant amount of compensation. The spherical aberration compensator 6 is a liquid crystal wavefront conversion element which is constructed, as shown in FIG. 8, from a planoconcave lens 31 and a planoconvex lens 32. The compensator is configured so that the planoconcave lens 31 can be moved in the direction of the optical axis by an actuator 35.

When the thickness of the transmissive substrate 8a is equal to the set value, the spacing between the planoconcave lens 31 and the planoconvex lens 32 is set so that the incoming wavefront to and the outgoing wavefront from the spherical aberration compensator 6 will not vary. When the thickness of the transmissive substrate 8a is not equal to the set value, the spacing between the planoconcave lens 31 and the planoconvex lens 32 is changed, causing the outgoing wavefront from the spherical aberration compensator 6 to vary, thereby allowing spherical aberration to be imparted to the spots on the recording layer 8b.

With such a configuration, a proportional relationship exists between the spacing between the planoconcave lens 31 and the planoconvex lens 32 and the amount of compensation of the transmissive substrate thickness error. Thus, the transmissive substrate thickness error signal SE can be directly used as a signal for changing the spacing between the planoconcave lens 31 and the planoconvex lens 32 to compensate for spherical aberration due to transmissive substrate thickness error.

Thus, in the optical disk drive equipped with the optical head thus configured, as shown in FIG. 8, an operation circuit 36 receives the outputs of the light receiving sections 12b and 12c of the photosensor 12 to produce the transmissive substrate thickness error signal SE as described previously. In response to the resulting transmissive substrate thickness error signal SE, a drive circuit 37 drives the actuator 35, allowing the spherical aberration compensator 6 to be controlled.

The entire area of the hologram 3 is not required to be the hologram region. It is required only that that area of the hologram which outputs the zero-order light component 52 and the ±first-order light components 53a and 53b that fall on the objective lens 7 be the hologram region. The other area of the hologram 3 may be a transparent substrate.

The numerical aperture of the objective lens 7 may be effectively decreased by making smaller the hologram region of the hologram 3 and thereby making smaller the area of the objective lens 7 on which the ±first-order light components 53a and 53b fall.

Furthermore, the focus error signal FE does not necessarily need to be produced on the principle of astigmatism. Likewise, the tracking error signal TE does not necessarily need to be produced on the push-pull principle.

In addition, the transmissive substrate thickness error signal SE may be obtained through operations utilizing the tracking error signals TE and TEa or TEb produced from the reflected light components 62 and 63a or 63b on the basis of the ratio of division between the zero-order light component 52 and the ±first-order light components 53a and 53b.

Moreover, it is also possible to use the differential push-pull principle utilizing the tracking error signals TEa and TEb based on the reflected light components 63a and 63b.

As described previously, the spots S53a and S53b based on the ±first-order light components 53a and 53b are formed in positions which are offset in the tracking direction by ±Pt/2 from the position of the spot S52 based on the zero-order light component 52. For this reason, the amplitude levels of the tracking error signals TEa and TEb will not become zero even after tracking control of the spot S52 based on the zero-order light component 52.

Thus, the transmissive substrate thickness error signal SE may be given by

SE=TEa−TEb

In this case, it is also possible to perform the focus control using the focus error signal FE based on the reflected light component 62, the tracking control using the tracking error signals TE, TEa and TEb based on the reflected light components 62, 63a and 63b, and the compensation control of the transmissive substrate thickness error using the transmissive substrate thickness error signal SE.

Furthermore, the spots S53a and S53b based on the ±first-order light components 53a and 53b may be formed in positions which are offset in the tracking direction by ±Pt/4 from the position of the spot S52 based on the zero-order light component 52.

The present invention is not limited to the disclosed embodiment but may be practiced or embodied in still other ways without departing from the scope and spirit thereof.

What is claimed is:

1. An optical head comprising:
a diffraction unit configured to diffract an incident beam of light emitted from a light source into a first light beam and a pair of second light beams;
a spherical aberration compensator configured to impart spherical aberration components based on an externally applied control input to the first light beam and the pair of second light beams output from the diffraction unit;
an objective lens configured to focus the first light beam and the pair of second light beams output from the spherical aberration compensator onto the recording layer of an optical disk; and
a photosensor configured to have light receiving sections each of which receives a corresponding one of the first light beam and the pair of second light beams reflected from the recording layer of the optical disk and transmitted through the objective lens.

2. An optical head according to claim 1, wherein the diffraction unit diffracts the incident beam of light into the first light beam and the pair of second light beams having tilt components of opposite polarization and spherical aberration components of opposite polarization but of the same amount.

3. An optical head according to claim 1, wherein the diffraction unit is divided into a light beam diffraction area which diffracts an incident light beam and a transparent substrate area which allows an incident light beam to pass through.

4. An optical head according to claim 1, wherein the diffraction unit is placed between the light source and a beam splitter which directs the first light beam and the pair of second light beams from the diffraction unit to the objective lens and then directs the first light beam and the pair of second light beams reflected from the recording layer of the optical disk to the photosensor.

5. An optical head according to claim 2, wherein the first light beam and the pair of second light beams are focused as spots onto the recording layer of the optical disk through the objective lens, the spots formed by the pair of second light beams being located on opposite sides of the spot formed by the first light beam in the tracking direction of the optical direction and offset by given amounts from the spot formed by the first light beam in the tracking direction.

6. An optical head according to claim 2, wherein the photosensor has a first light receiving section configured to receive the first light beam reflected from the recording layer of the optical disk, a second light receiving section configured to receive one of the pair of second light beams reflected from the recording layer of the optical disk, and a third light receiving section configured to receive the other of the pair of second light beams reflected from the recording layer of the optical disk,
the first light receiving section having a plurality of light receiving areas configured to provide output signals which are operated on to produce a tracking error signal and a focus error signal for the spot formed by the first light beam on the recording layer of the optical disk,
the second light receiving section having a plurality of light receiving areas configured to provide output signals which are operated on to produce a tracking error signal for the spot formed by the one of the pair of second light beams on the recording layer of the optical disk, and
the third light receiving section having a plurality of light receiving areas configured to provide output signals which are operated on to produce a tracking error signal for the spot formed by the other of the pair of second light beams on the recording layer of the optical disk.

7. An optical head according to claim 1, wherein the diffraction unit is a hologram that diffracts the incident beam of light into zero-order light adapted to record or reproduce information onto or from the optical disk and ±first-order light having tilt components of opposite polarization and spherical aberration components of opposite polarization but of the same amount and adapted to detect an error in the transmissive substrate of the optical disk.

8. An optical head according to claim 7, wherein the zero-order light and the ±first-order light are focused as spots onto the recording layer of the optical disk through the objective lens, the spots formed by the ±first-order light being offset from the spot formed by the first-order light by ±Pt/2 or ±Pt/4 in the tracking direction of the optical disk, wherein Pt is the track pitch on the recording layer of the optical disk.

9. An optical head according to claim 1, wherein the spherical aberration compensator is a liquid crystal wavefront conversion element configured to change its outgoing wavefront with respect to its incoming wavefront in accordance with an externally applied control signal.

10. An optical head according to claim 1, wherein the spherical aberration compensator has a concave lens and a convex lens which are juxtaposed and is configured to change the spacing of the lenses in accordance with an externally applied control signal.

11. An optical disk drive comprising:
an optical head comprising a diffraction unit configured to diffract an incident beam of light emitted from a light source into a first light beam and a pair of second light beams, a spherical aberration compensator configured to impart spherical aberration components based on an externally applied control signal to the first light beam and the pair of second light beams output from the diffraction unit, an objective lens configured to focus the first light beam and the pair of second light beams output from the spherical aberration compensator onto the recording layer of an optical disk, and a photosensor configured to have light receiving sections each of which receives a corresponding one of the first light beam and the pair of second light beams reflected from the recording layer of the optical disk and transmitted through the objective lens; and
a detecting unit configured to detect an error in the thickness of the transmissive substrate of the optical disk on the basis of outputs of the photosensor.

12. An optical disk drive according to claim 11, wherein the detecting unit detects the error in the thickness of the transmissive substrate of the optical disk on the basis of an output signal of a light receiving section which receives the first light beam and an output signal of a light receiving section which receives one of the pair of second light beams.

13. An optical disk drive according to claim 11, wherein the detecting unit produces a first tracking error signal for a spot formed on the recording layer of the optical disk by one of the pair of second light beams on the basis of an output signal of the light receiving section that receives the one of the pair of second light beams and a second tracking error signal for a spot formed on the recording layer of the optical disk by the other of the pair of second light beams on the basis of an output signal of the light receiving section that receives the other of the pair of second light beams, and detects the error in the thickness of the transmissive substrate of the optical disk on the basis of the first and second tracking error signals.

14. An optical disk drive according to claim 13, wherein the detecting unit produces a signal corresponding to the error in the thickness of the transmissive substrate of the optical disk on the basis of the difference between the first and second tracking error signals.

15. An optical disk drive according to claim 13, further comprising a control signal producing unit configured to produce the control signal to be applied to the spherical aberration compensator on the basis of the error in the thickness of the transmissive substrate of the optical disk detected by the detecting unit.

16. An optical disk drive according to claim 15, wherein the control of the spherical aberration compensator by the control signal producing unit is performed between focus control and tracking control.

17. An optical disk drive according to claim 15, wherein the control of the spherical aberration compensator by the control signal producing unit is performed after focus control and tracking control.
